(19) United States
(12) Patent Application Publication
(10) Pub. No.: US 2022/0178459 A1
(43) Pub. Date: Jun. 9, 2022

(54) LETHAL AND SEVERE SERVICE MAGNETICALLY ACTUATED VALVES AND RETROFIT KITS

(71) Applicant: Edward P. Davis, Kihei, HI (US)

(72) Inventor: Edward P. Davis, Kihei, HI (US)

(21) Appl. No.: 17/540,963

(22) Filed: Dec. 2, 2021

Related U.S. Application Data
(60) Provisional application No. 63/122,629, filed on Dec. 8, 2020.

(51) Int. Cl. F16K 31/08

(52) U.S. Cl. CPC F16K 31/082; F16K 31/0655

(57) ABSTRACT

Lethal and Severe Service Magnetically Actuated Valves and Retrofit Kits is disclosed. My invention encapsulates a magnetically permeable, but ordinarily non-magnetic piece of metal such as iron, steel, or ferritic stainless inside the exotic alloys and compatible materials such as Monel, Inconel, Hastelloy, Alloy 20, PTFE, TFM or PTA that are necessary to construct modern severe and lethal service valves.

### CROSS-REFERENCE TO RELATED APPLICATIONS

This application claims the benefit of U.S. Provisional Application No. 63/122,629 filed Dec. 8, 2020, the disclosure of which is incorporated herein by reference in its entirety.

### FIELD

This application relates to valve technology and, more specifically, to valve actuator mechanisms.

### BACKGROUND

Valves often develop leaks as they age. Leaking valves can be annoying, wasteful, and can cause damage in residential settings, but can be far more problematic in industrial applications. Factory lines may need to be shut down to repack or replace valves, resulting in lost production and unnecessary downtime. Leaks can cause environmental damage and safety issues. Steam leaks can scald and even kill workers. The Environmental Protection Agency (EPA) is concerned about pollution resulting from leaky valve stem seals in factories and oil fields. In extreme cases, such as semiconductor manufacturing, even microscopic leaks can be fatal—breathing tanks and hazmat suits are often required to clean up after leaks are detected in semiconductor foundries.

Most traditional valves usually have two moving seals: (1) the Seat where the flow of material through the valve is allowed, controlled, and shut off, and (2) the Stem seal that keeps the material from leaking out of the hole for the valve handle. Studies have shown that some high percentage of the leaks encountered in real world valves are associated with the stem seals because they tend to entrain dirt and grit which can erode the mating surfaces over time.

Traditional valves contain stem seals that often degrade or leak over time. Previous seal-less valves often employed bending or flexing components such as bellows or membranes that can degrade or fatigue and also leak long term. Additionally, previous generations of magnetic valves usually contained internal magnets and/or operated in an on/off solenoid type manner making high temperature operation difficult to achieve for most applications.

Bellows valves leak, fatigue, and can fail catastrophically in time. They have pressure, size, and material compatibility limitations, and tend to be very expensive. Previous magnetic valves could not handle high temperatures, couldn't be welded shut, and were not compatible with severe working fluids or the alloys that can work with them.

My invention encapsulates a magnetically permeable, but ordinarily non-magnetic piece of metal such as iron, steel, or ferritic stainless inside exotic alloys or materials such as Monel, Inconel, Hastelloy, Alloy 20, PTFE, TFM or PTA that are necessary to construct modern severe and lethal service valves. This is necessary because the working fluids inside of these valves are extremely corrosive, caustic, reactive, toxic, explosive, etc. that ordinary materials such as steel, brass, and even stainless steel cannot effectively contain them.

This approach is not ordinarily possible with a traditional permanent magnet based magnetic coupling such as those employed in previous generations of magnetic valves and couplings. Even the highest temperature rated Samarium Cobalt magnets cannot withstand the temperatures necessary to weld the exotic alloys needed for many lethal and severe service valves, and magnets such as AlNiCo's that can withstand such temperatures tend to be much weaker and prone to demagnetization if the coupling slip were to slip.

### SUMMARY

Systems and methods are provided for magnet-actuated valves that are able to handle caustic, corrosive, reactive, and other dangerous working fluids.

As stated above, this invention prevents, repairs, and completely eliminates leaks of toxic and dangerous substances from valves constructed from exotic materials such as those employed for lethal and severe service applications.

My invention uses a magnetic coupling to eliminate or enclose the stem seal of a valve, especially one employed in lethal or severe service applications. It is able to do this for two reasons: The magnets are kept outside the valve bonnet completely, and the materials that conduct and/or allow the magnetic flux to pass through the bonnet or interact with it inside the bonnet are encased or enclosed with suitable compatible materials such as Monel, Inconel, Hastelloy, Alloy 20, PTFE, TFM or PTA.

The claimed invention differs from what currently exists. My invention is the only truly hermetically sealed valve solution suitable for severe and lethal service valves, especially those employing more exotic alloys and materials that must be formed, welded, or cast at temperatures higher than the typical curie temperatures of modern high strength magnets.

This invention is an improvement on what currently exists. My invention is the only truly hermetically sealed valve solution suitable for severe and lethal service valves, especially those employing more exotic alloys and materials.

Bellows can fail catastrophically while in use resulting in severe safety hazards. Previous versions of magnetic valves simply were not compatible with many severe working fluids.

My invention encapsulates a magnetically permeable, but ordinarily non-magnetic piece of metal such as iron, steel, or ferritic stainless inside the exotic alloys and other compatible materials such as Monel, Inconel, Alloy 20, PTFE, TFM or PTA that are necessary to construct modern severe and lethal service valves. Examples of this encapsulation mechanism is shown in FIGS. 1 and 2, or alternatively, the encapsulation could be a thin coating of material.

It can be employed for gate valves as shown in FIGS. 3-5, globe valves as shown in FIG. 6, ball valves as shown in FIG. 7, retrofit kits as shown in FIG. 8, linearly actuated valves as shown in FIG. 9, and other valves such as plug valves not depicted here.

Also, it can produce a system or network of multiple magnetically actuated valves deployed in series or in a network to improve the overall valve system reliability including the seat and corresponding leak-thru likelihood and rate to any arbitrary reliability desired, such as six-sigma.

In accordance with various embodiments of the present invention, a valve assembly is generally described. In some examples, the valve assembly may comprise a valve body defining an enclosure. In some other examples, the valve assembly may further comprise a stem disposed in the enclosure. In various other examples, the valve assembly may further comprise a movable valve actuator component disposed in the enclosure and operatively coupled to a first end of the stem. In some examples, the valve assembly may further comprise an internal actuator having a ferromagnetic portion. In some examples, the ferromagnetic portion of the internal actuation mechanism may be encased or encapsulated within special alloys or materials such as such as Monel, Inconel, Hastelloy, Alloy 20, PTFE, TFM or PTA. in order to protect the ferromagnetic portion of the internal actuation mechanism from the working fluid within thew valve. In various examples, the internal actuator may be operatively coupled to a second end of the stem. In some other examples, the valve assembly may further comprise an external actuator operatively coupled to an exterior of the valve body. In some examples, the external actuator may comprise a first magnetic pole section adjacent to the valve body. In some examples, the external actuator may comprise a second magnetic pole section adjacent to the valve body.

In accordance with embodiments of the present invention, a valve assembly is provided. The valve assembly comprises: an internal actuator comprising: a ferromagnetic encased, enclosed, or surrounded by a different material.

The valve assembly may further comprise a valve body defining an enclosure, wherein the internal actuator is disposed in the enclosure; and an external actuator coupled to an exterior of the valve body, the external actuator comprising a first magnetic pole section and a second magnetic pole section adjacent to the valve body; wherein, when the first actuator component is aligned with the second actuator component at the first angular displacement, the first magnetic pole section is magnetically coupled to the first actuator component and the second magnetic pole section is magnetically coupled to the free end of the second actuator component, and rotation of the external actuator in the first direction effectuates rotation of the internal actuator in the first direction.

In various embodiments, the internal actuator comprises a ferromagnetic material, or an impermanently magnetic material encased within a nonmagnetic material that may be more suitable for the fluid being handled by the valve.

In some embodiments, the internal actuator is disposed in the enclosure; and an external actuator coupled to an exterior of the valve body, the external actuator comprising a first magnetic pole section and a second magnetic pole section adjacent to the valve body; wherein, when the first actuator component is aligned with the second actuator component at the first linear displacement, the first magnetic pole section is magnetically coupled to the first actuator component and the second magnetic pole section is magnetically coupled to the free end of the second actuator component, and translation of the external actuator in the first direction translation rotation of the internal actuator in the first direction.

In some embodiments, the valve assembly further comprises a valve member effective to open and close a fluid flow path of the valve assembly; and a valve stem operatively coupled to the internal actuator and to the valve member.

The various magnetic valve actuators described herein may be particularly useful for valves that close by pressing a moving actuator component against a fixed seat such as gate, globe, and/or butterfly valves, as such particular varieties of valves. Furthermore, the various magnetic valve actuators described herein may offer improved reliability relative to previous solutions such as springs that flex, fatigue, and/or degrade over time.

In other embodiments, the magnetic valve actuators described herein may be useful for ball or plug valves.

As previously described, the working fluids inside of valves meant for lethal and severe applications may be extremely corrosive, caustic, reactive, toxic, explosive, etc. such that ordinary materials such as steel, brass, and even stainless steel cannot effectively contain them.

The encapsulated magnetic valve actuators described herein may overcome this problem by allowing a ferromagnetically susceptible material to be encased in a more exotic alloy suitable for working with these challenging working fluids. By employing a ferromagnetic material such as steel, iron, or stainless steel, rather than permanent magnets, high temperature sealing operations such as welding, brazing, and casting can be employed to completely encapsulate and protect the ferromagnetic portion of the valve actuator mechanism from the working fluid.

Still other embodiments of the present disclosure will become readily apparent to those skilled in the art from the following detailed description, which describes embodiments illustrating various examples of the invention. As will be realized, the invention is capable of other and different embodiments and its several details are capable of modifications in various respects, all without departing from the spirit and the scope of the present invention. Accordingly, the drawings and detailed description are to be regarded as illustrative in nature and not as restrictive.

### BRIEF DESCRIPTION OF DRAWINGS

FIG. 1 depicts a side cut-away view of a Magnetically Permeable Core encased in Encapsulating Material, in accordance with some aspects of the present disclosure;

FIG. 2 depicts a side cut-away view of a Magnetically Permeable Core encased in Encapsulating Material with an Encapsulation Plug, in accordance with some aspects of the present disclosure;

FIG. 3 depicts a side cut-away view of a Gate Valve with Connecting Pipes, Bonnet, Gate, Internal Stem, Magnetically Permeable Core with Encapsulating Material and Encapsulating Material Welds, Internal Support Member, External Magnets, Back Iron, and External Actuator Body, in accordance with some aspects of the present disclosure;

FIG. 4 depicts a side cut-away view of a Gate Valve with Connecting Pipes, Bonnet, Gate, Internal Stem, Magnetically Permeable Core with Encapsulating Container and Encapsulation Plug, Internal Support Member, External Magnets, Back Iron and External Actuator Body, in accordance with some aspects of the present disclosure;

FIG. 5 depicts a side cut-away view of a Gate Valve with Connecting Pipes, Bonnet, Gate, Internal Stem, Magnetically Permeable Core with Encapsulating Material and Encapsulating Material Welds, Internal Support Member, Bonnet Liner, External Magnets, Back Iron, and External Actuator Body, in accordance with some aspects of the present disclosure;

FIG. 6 depicts a side cut-away view of a Globe Valve, with two Magnetically Permeable Cores in Encapsulating Material with Welds, and two pairs of External Magnets, in accordance with some aspects of the present disclosure;

FIG. 7 depicts a side cut-away view of a Ball Valve with Connecting Pipes, Bonnet, Ball, Internal Stem, Magnetically Permeable Core with Encapsulating Material and Encapsulating Material Welds, External Magnets, Back Iron, and External Actuator Body, in accordance with some aspects of the present disclosure;

FIG. 8 depicts a side cut-away view of a Gate Valve, Legacy Bonnet, Retrofit Kit Saddle, Retrofit Bonnet, Gate, Internal Stem, Magnetically Permeable Core with Encapsulating Material and Encapsulating Material Welds, Bonnet Liner, Static Seal, Gland Seal, Gland Packing Nut, Retrofit Kit Bolts and Nuts, External Magnets, Back Iron, and External Actuator Body, in accordance with some aspects of the present disclosure;

FIG. 9 depicts a side cut-away view of a Linearly Actuated Gate Valve with Connecting Ports, Bonnet, Gate, Internal Stem, Multiple Magnetically Permeable Cores encased in Encapsulating Material, External Magnets, and Back Iron, in accordance with some aspects of the present disclosure;

### DETAILED DESCRIPTION

In the following description, reference is made to the accompanying drawings that illustrate several embodiments of the present disclosure. It is to be understood that other embodiments may be utilized and system or process changes may be made without departing from the spirit and scope of the present disclosure. The following detailed description is not to be taken in a limiting sense, and the scope of the embodiments of the present invention is defined only by the claims of the issued patent. It is to be understood that drawings are not necessarily drawn to scale.

Various embodiments of the present disclosure provide improved systems and methods for actuating valves using encapsulated magnetic valve actuators as described herein. These embodiments may provide improved durability and leak-resistance and may prevent valves from being damaged by corrosive, caustic, reactive, toxic, explosive, or otherwise challenging working fluids. Additionally, these enclosed magnetic valve actuators described herein overcome various technical challenges presented when using conventional magnetic valves.

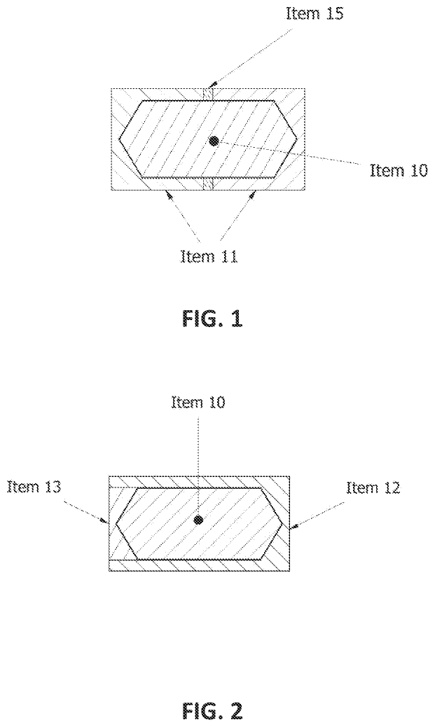

FIG. 1 depicts a side cut-away view (perpendicular to the axis of rotation) of a Magnetically Permeable Core (Item 10), encased in Encapsulating Material (Item 11), sealed with an Encapsulating Material Weld (Item 15) at top and bottom of Item 10;

FIG. 2 depicts a side view (perpendicular to the axis of rotation) of a Magnetically Permeable Core (Item 10), placed in an Encapsulating Container (Item 12), sealed with an Encapsulation Plug (Item 13);

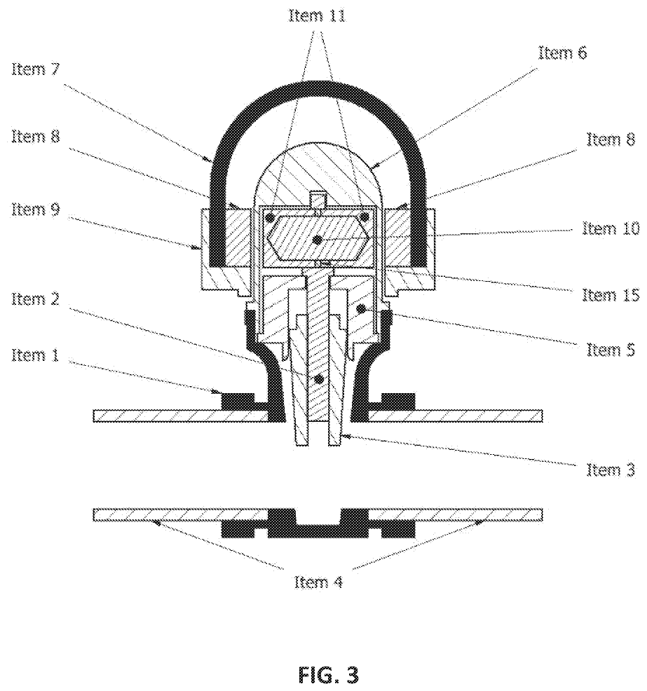

FIG. 3 depicts an assembled side view of a Gate Valve (perpendicular to the axis of rotation) with a Magnetically Permeable Core (Item 10), encased in Encapsulating Material (Item 11) sealed at top and bottom with Encapsulating Material Weld (Item 15), enclosed in a Bonnet (Item 6) set in a Valve Body (Item 1) with attached Connecting Ports (Item 4), actuated by External Magnets (Item 8), held by a Back Iron (Item 7), supported by an External Actuator Body (Item 9), the Gate (Item 3) is raised or lowered with the rotation of the Internal Stem (Item 2) welded to Item 11, threaded through an Internal Support Member (Item 5);

Item 10, the permeable core is made from iron, steel, or 400 series stainless and is encased in items 11 and 15 or 12 and 13 made from materials such as Monel, Inconel, Alloy 20, PTFE, TFM or PTA that are compatible with dangerous or caustic working fluids such as H2S or HF. The external actuation mechanism, made from Items 7, 8, and 9 causes Item 10 to move when the external actuation mechanism moves via magnetic attraction and/or repulsion. Item 10 moves Item 2, the internal stem or leadscrew, which in turn moves Item 3 the valve element such as the gate shown in FIG. 3, perhaps by pushing against Item 5, an internal support member. This serves to control the working fluid passing between ports or connecting pipes Item 4.

Items 5, 7, and 14 are optional, but may improve the performance of the system.

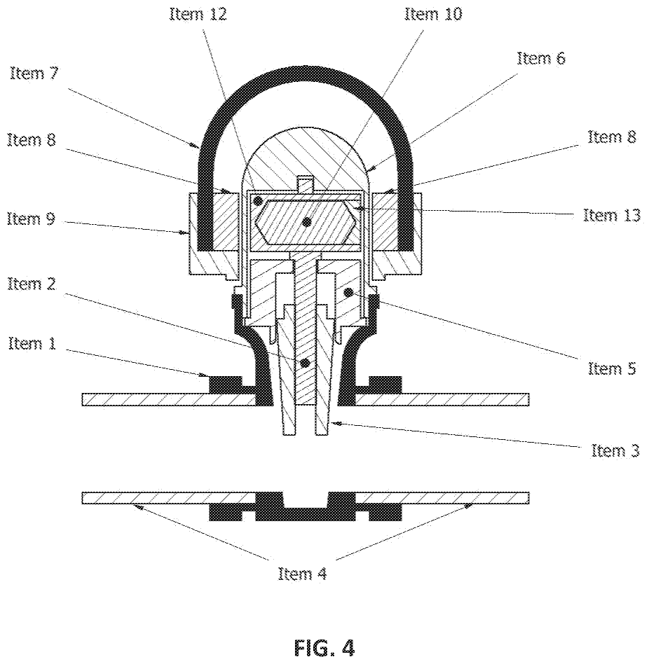

FIG. 4 depicts an assembled side view of a Gate Valve (perpendicular to the axis of rotation) with a Magnetically Permeable Core (Item 10) sealed in an Encapsulating Container (Item 12) with an Encapsulation Plug (Item 13), in accordance with various aspects of the present disclosure. Those portions of FIG. 4 that have been previously described with reference to FIGS. 1-3 may not be described again herein for purposes of clarity and brevity.

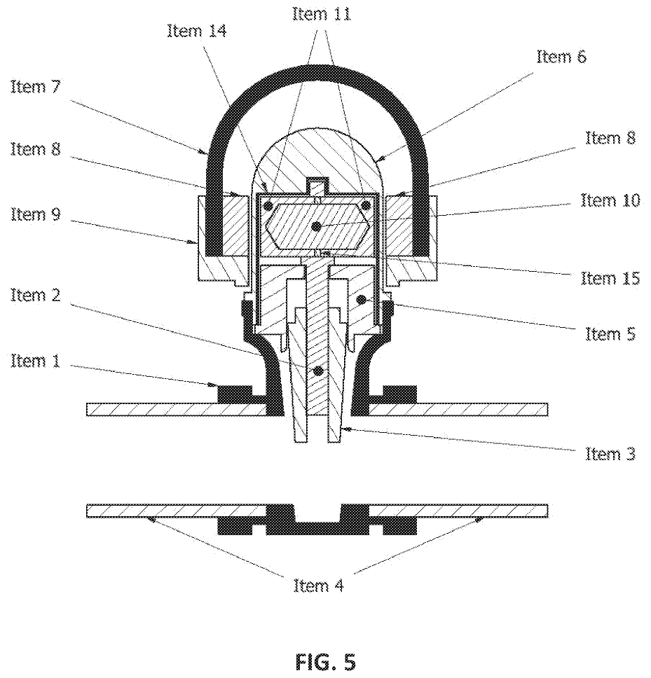

FIG. 5 depicts an assembled side view of a Gate Valve (perpendicular to the axis of rotation) with a Bonnet Liner (Item 14), in accordance with various aspects of the present disclosure. Those portions of FIG. 5 that have been previously described with reference to FIGS. 1-4 may not be described again herein for purposes of clarity and brevity.

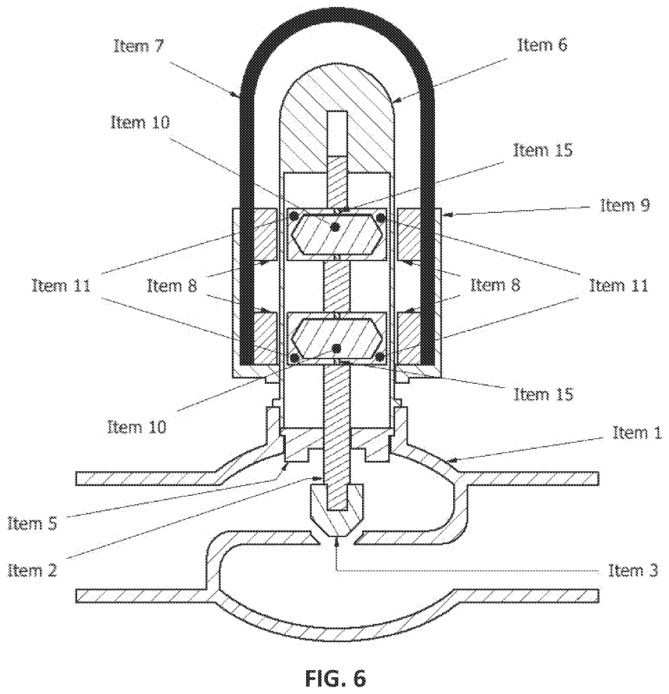

FIG. 6 depicts a side cut-away view of a Globe Valve, with two Magnetically Permeable Cores (Items 10) in Encapsulating Material with Welds (Items 11), and two pairs of External Magnets (Items 8), which may result in enhanced operational torque, in accordance with various aspects of the present disclosure. Those portions of FIG. 6 that have been previously described with reference to FIGS. 1-5 may not be described again herein for purposes of clarity and brevity.

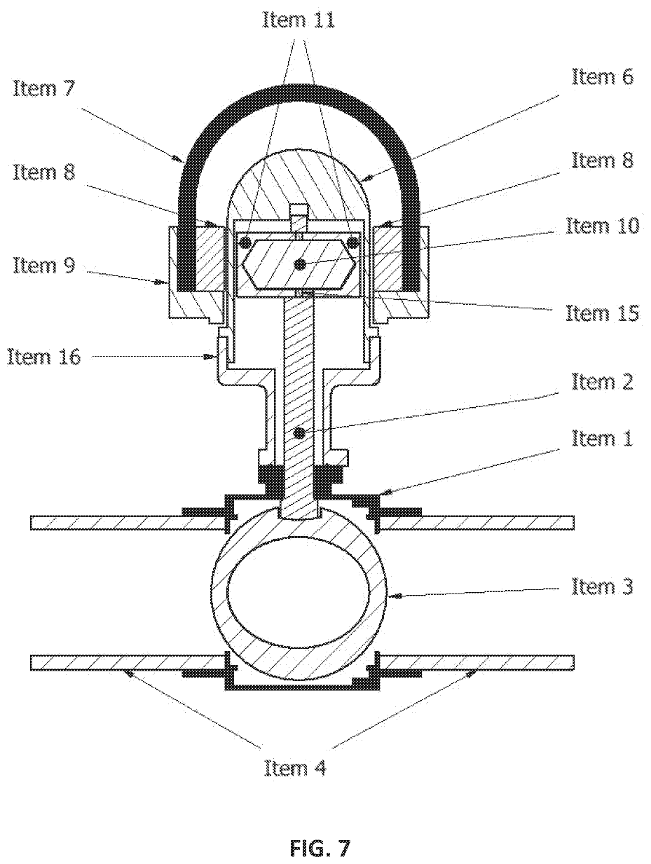

FIG. 7 depicts a side cut-away view of a Ball Valve with a Ball shaped occluding component (Item 3) of the valve and showing an optional External Connection Member for Ball Valve (Item 16), in accordance with various aspects of the present disclosure. Those portions of FIG. 7 that have been previously described with reference to FIGS. 1-6 may not be described again herein for purposes of clarity and brevity.

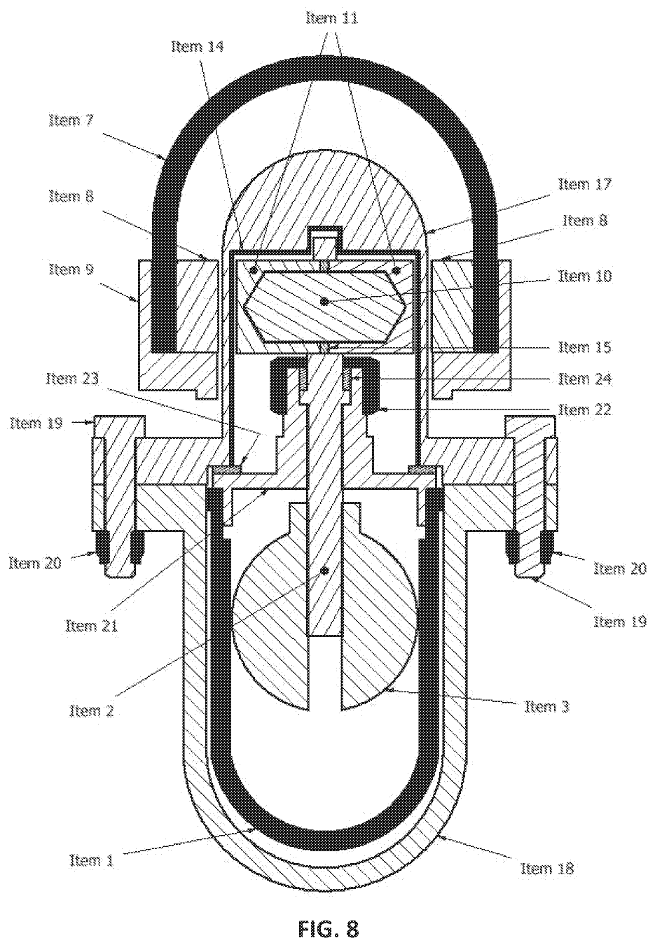

FIG. 8 depicts a side cut-away view of a Gate Valve sealed with a retrofit kit consisting of items 17-20 and Item 23. The Legacy Bonnet (Item 21), Gland Seal (Item 24), and Gland Packing Nut (Item 22), are enclosed within the Retrofit Bonnet (Item 17), and held in place by the Retrofit Kit Saddle or Securing Hardware (Item 18), Bolts (Item 19), and Nuts (Item 20), and sealed with Static Seal (Item 23)—Perhaps even while the valve is in use. Item 17, the Retrofit Kit Valve Bonnet attaches to Item 1, the Valve Body or Item 21 the legacy/existing bonnet with a static seal or weld that again will not move as the valve actuates, flex, leak, or degrade. Some combination of Items 17 thru 24 are generally necessary for the retrofit kit version of this invention, though perhaps 18 and 19 might be combined—For example as a U-Bolt, in accordance with various aspects of the present disclosure. Those portions of FIG. 8 that have been previously described with reference to FIGS. 1-7 may not be described again herein for purposes of clarity and brevity.

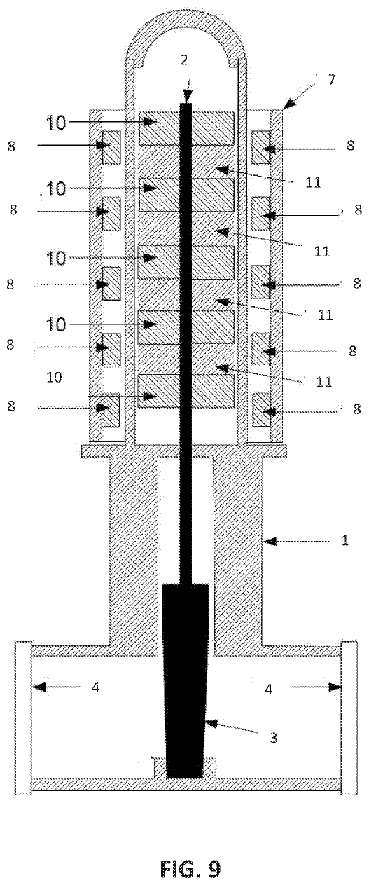

FIG. 9 depicts a side cut-away view of a Linearly Actuated Gate Valve, with two Magnetically Permeable Cores (Items 10) in Encapsulating Material with Welds (Items 11), and two pairs of External Magnets (Items 8), which moves in a linear rather than rotational manner, in accordance with various aspects of the present disclosure. Those portions of FIG. 9 that have been previously described with reference to FIGS. 1-8 may not be described again herein for purposes of clarity and brevity.

Magnetic flux is transmitted across sealed interfaces from outside the valve to inside the valve, and from outside the encapsulation materials to inside them, in a manner such that the orientation of the external actuation mechanism consisting of items 7, 8, and 9 corresponds to a preferred orientation of the internal portion of the actuation mechanism, Item 10, and hence motion of the external actuation mechanism results in motion of the internal actuation mechanism, allowing the valve to be opened and closed without a physical penetration of the valve stem through the bonnet (Item 6). Furthermore, by encapsulation the internal portion of the actuation mechanism 10 within encapsulating materials 11, 12, 13, and 15, and perhaps employing bonnet liner 14, all materials exposed to the working fluid can be compatible with it, while still allowing the internal portion of the actuation mechanism, Item 10 to conduct magnetic flux and hence have a preferred orientation or position with respect to the external magnetic actuator and thereby transmit motion across the sealed bonnet Item 6 or 17 depending on the embodiment of the invention. Some combination of Items 11, 12, 13, and 15 sufficient to encase and protect Item 10 are necessary in most embodiments constructed from all distinct physical parts, though a thin coating of material applied by a deposition process or even a dipping process would also likely suffice in many other applications—this would result in a thin layer of a compatible material coating the internal actuation member Item 10 (and perhaps the bonnet Item 6 or 17 as well).

Items 7 thru 9, the external actuation mechanism, may in some embodiments move in a linear or sliding rather than rotating fashion, as shown in FIG. 9, as would Item 10, the internal magnetic actuation member in this sort of embodiment.

A valve may be constructed to include the magnetic actuation mechanism from the start, and Item 6 the valve bonnet, may even be welded, brazed, or soldered in place prior to attaching Items 7 thru 9 that comprise the external actuation mechanism. Regardless, in this invention, Item 10, the internal portion of the magnetic actuation mechanism must be encased in some combination of Items 11, 12, 13, and Weld 15 in order to protect Item 10 from very corrosive or potentially incompatible working fluids should they enter the bonnet cavity. In some embodiments of the invention, the bonnet itself must be lined with bonnet liner 14 for material compatibility (and to allow the bulk of the bonnet to pass and not short out the magnetic flux of the actuation mechanism).

Among other potential benefits, valves in accordance with embodiments of the present disclosure may alleviate the problem of valves leaking, and especially valves leaking dangerous and/or difficult to contain substances such as acids, bases, and toxic gasses and fluids. Traditional valves contain stem seals that often degrade or leak over time. Previous seal-less valves often employed bending or flexing components such as bellows or membranes that can degrade or fatigue and also leak long term. Additionally, previous generations of magnetic valves usually contained internal magnets and/or operated in an on/off solenoid type manner making high temperature operation difficult to achieve for most applications. Previous magnetic valves could not handle high temperatures, couldn't be welded shut, and were not compatible with severe working fluids or the alloys that can work with them.

The invention and embodiments described herein encapsulate magnetically permeable, but ordinarily non-magnetic materials such as iron, steel, or ferritic stainless inside exotic alloys or materials such as Monel, Inconel, Hastelloy, Alloy 20, PTFE, TFM or PTA that are necessary to construct modern severe and lethal service valves. This is necessary because the working fluids inside of some valves are extremely corrosive, caustic, reactive, toxic, explosive, etc. that ordinary materials such as steel, brass, and even stainless steel cannot effectively contain them.

This approach is not ordinarily possible with a traditional permanent magnet based magnetic coupling such as those employed in previous generations of magnetic valves and couplings. Even the highest temperature rated Samarium Cobalt magnets cannot withstand the temperatures necessary to weld the exotic alloys needed for many lethal and severe service valves.

The retrofit kit version of the magnetically actuated valves as shown in FIG. 8 could be installed on a valve that is already leaking or in operation, or alternatively be installed on a brand-new valve prior to installation in order to be more easily certified/maintain existing valve certifications. Once installed, the retrofit version also operates like the other magnetic valve versions and the legacy valve that it would/could replace.

Multiple magnetically actuated valves such as this can be deployed in series or in a network to improve the overall valve system reliability including the seat and corresponding probability of leaks through the valves to any arbitrary reliability desired, such as six-sigma. The magnetic coupling components of this invention could also be used alone as a magnetic coupling—for example for lethal or severe service pumps and compressors.

Accordingly, the various embodiments described herein offer technological improvements over previous valve actuators and over magnetic valve actuators in particular.

While the invention has been described in terms of particular embodiments and illustrative figures, those of ordinary skill in the art will recognize that the invention is not limited to the embodiments or figures described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one” or “one or more.” Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While specific embodiments and examples for the disclosure are described herein for illustrative purposes, various equivalent modifications are possible within the scope of the disclosure, as those skilled in the relevant art will recognize. Such modifications may include, but are not limited to, changes in the dimensions and/or the materials shown in the disclosed embodiments.

Specific elements of any embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A valve assembly, comprising:
a valve body defining an enclosure;
a movable valve member disposed in the enclosure;
an internal actuation member containing a ferromagnetic portion comprising an impermanent magnet encased in some other material, the internal actuation member operatively coupled to the movable valve member;
an external actuator attached to an exterior of the valve body, the external actuator comprising:
a first magnetic pole section adjacent to the valve body;
a second magnetic pole section adjacent to the valve body, wherein
when the external actuator is in a first rotational position relative to the internal actuation member there is at least a first magnetic reluctance between the first magnetic pole section, the second magnetic pole section, and the internal actuation member, and when the external actuator is in a second rotational position relative to the internal actuation member there is at least a second magnetic reluctance between the first magnetic pole section, the second magnetic pole section, and the internal actuation member, wherein the second magnetic reluctance is lower than the first magnetic reluctance such that when the external actuator is in the second rotational position, magnetic flux paths from the first magnetic pole section, through the ferromagnetic portion, to the second magnetic pole section have a magnetic field strength sufficient to cause rotation of the internal actuation member when the external actuator is rotated; and
an impermanently magnetic ferromagnetic material completing a return flow path for magnetic flux between the first magnetic pole section and the second magnetic pole section.

2. The valve assembly of claim 1, wherein the internal actuation member comprises an elongate ferromagnetic material member encased in some other material having a first end aligned with the first magnetic pole section and a second end aligned with the second magnetic pole section.

3. The valve assembly of claim 1, wherein the internal actuation member comprises an elongate ferromagnetic material member enclosed, coated, dipped, or cast inside some other material that is more compatible with the working fluid of the valve.

4. The valve assembly of claim 1, wherein magnetic flux of the magnetic flux paths is effective to orient the internal actuation member in the second rotational position.

5. The valve assembly of claim 1, wherein at least a portion of the valve body comprises a cylindrical portion containing the internal actuation member;
the external actuator further comprises an annular base portion concentric with the cylindrical portion of the valve body;
the first magnetic pole section is disposed at a first location of the annular base portion; and
the second magnetic pole section is disposed at a second location of the annular base portion.

6. The valve assembly of claim 1, wherein the first magnetic pole section and the second magnetic pole section comprise a magnet with the first magnetic pole section being a north pole of the magnet and the second magnetic pole section being a south pole of the magnet.

7. The valve assembly of claim 1, wherein the internal actuation member is disposed in a cavity of the valve body, wherein the cavity is sealed such that the external actuator is not mechanically coupled to the internal actuation member or a stem of the valve assembly.

8. The valve assembly of claim 1, further comprising a first port and a second port separated by the movable valve member.

9. The valve assembly of claim 1, wherein the external actuator is removable from the valve body such that the valve body may be heated without heating the external actuator, the first magnetic pole section, and the second magnetic pole section.

10. A valve comprising:
a valve body having an interior portion and an exterior portion, the interior portion defining a cavity;
a movable valve member movable between an open position and a closed position;
an internal actuation member having a ferromagnetic portion comprising an impermanent magnet disposed in the cavity and encased in another material, the internal actuation member operatively coupled to the movable valve member such that rotation of the internal actuation member actuates movement of the movable valve member between the open position and the closed position; and
an external actuator attached to the exterior portion of the valve body, the external actuator comprising:
a first magnetic pole section adjacent to the exterior portion of the valve body;
a second magnetic pole section adjacent to the exterior portion of the valve body, wherein magnetic flux flows from the first magnetic pole section through the ferromagnetic portion to the second magnetic pole section in a magnetic flux path through the interior portion of the valve, the magnetic flux having a magnitude sufficient to cause movement of the internal actuation member in response to rotation of the external actuator, wherein the external actuator and the internal actuation member are configured to remain adjacent to one another during rotation of the external actuator; and
an impermanently magnetic ferromagnetic material completing a return flow path for the magnetic flux between the first magnetic pole section and the second magnetic pole section.

11. The valve of claim 10, wherein the internal actuation member comprises an elongate ferromagnetic material member encased, coated, or enclosed in some other material having a first end aligned with the first magnetic pole section and a second end aligned with the second magnetic pole section.

13. The valve of claim 10, wherein the magnetic flux is effective to orient the internal actuation member in a first orientation with respect to the first magnetic pole section and the second magnetic pole section.

14. The valve of claim 10, wherein an aligned orientation of the internal actuation member with respect to the external actuator results in a lower magnetic reluctance than other orientations of the internal actuation member with respect to the external actuator.

15. The valve of claim 10, wherein the valve body comprises a cylindrical portion containing the internal actuation member;
the external actuator comprises an annular base portion concentric with the cylindrical portion of the valve body;
the first magnetic pole section is disposed at a first location of the annular base portion; and
the second magnetic pole section is disposed at a second location of the annular base portion.

16. The valve of claim 10, wherein the cavity is sealed such that the external actuator is not mechanically coupled to the internal actuation member or a stem coupled to the movable valve member.

17. A valve assembly, comprising:
a valve bonnet;
a valve stem disposed in the valve bonnet;
a valve member coupled to a distal end of the valve stem, the valve member movable between a first position in which the valve assembly is closed and a second position in which the valve assembly is open;
a first internal ferromagnetic actuation member coupled to the valve stem and encased in another material;
a second internal ferromagnetic actuation member coupled to the valve stem and encased in another material, wherein the first internal ferromagnetic actuation member and the second internal ferromagnetic actuation member are disposed in a spaced relationship along the valve stem; and
an external actuator slidably engaged to an exterior surface of the valve bonnet, the external actuator comprising:
a first magnet magnetically coupled to the first internal ferromagnetic actuation member through the valve bonnet; and
a second magnet magnetically coupled to the second internal ferromagnetic actuation member through the valve bonnet;
wherein linear translation of the external actuator in a first direction causes the first magnet to apply a first force on the first internal ferromagnetic actuation member in the first direction and causes the second magnet to apply a second force on the second internal ferromagnetic actuation member in the first direction, wherein the first force and the second force are effective to linearly translate the valve stem, causing linear translation of the valve member into the first position; and
wherein linear translation of the external actuator in a second direction causes the first magnet to apply a third force on the first internal ferromagnetic actuation member in the second direction and causes the second magnet to apply a fourth force on the second internal ferromagnetic actuation member in the second direction, wherein the third force and the fourth force are effective to linearly translate the valve stem, causing linear translation of the valve member into the second position.

18. The valve assembly of claim 17, wherein:
the first internal ferromagnetic actuation member comprises an opening through which the valve stem is slidably engaged.

19. The valve assembly of claim 18, wherein:
the second internal ferromagnetic actuation member is rigidly coupled to the valve stem.

20. The valve assembly of claim 17, wherein the valve bonnet is a first bonnet, and wherein the first internal ferromagnetic actuation member and the second internal ferromagnetic actuation member are disposed in a first stack in the first bonnet, the valve assembly further comprising:
a second bonnet;
a third internal ferromagnetic actuation member encased in another material; and
a fourth internal ferromagnetic actuation member encased in another material, wherein the third internal ferromagnetic actuation member and the fourth internal ferromagnetic actuation member are disposed in a second stack in the second bonnet.

21. The valve assembly of claim 17, further comprising a non-ferromagnetic material disposed between the first internal ferromagnetic actuation member and the second internal ferromagnetic actuation member.

22. A method of actuating a valve, the method comprising:
moving an external actuator slidably engaged to an exterior surface of a valve bonnet in a first direction, the external actuator comprising:
a first magnet magnetically coupled to a first internal ferromagnetic actuation member encased in another material disposed within the valve bonnet; and
a second magnet magnetically coupled to a second internal ferromagnetic actuation member encased in another material disposed within the valve bonnet;
wherein linear translation of the external actuator in a first direction causes the first magnet to apply a first force on the first internal ferromagnetic actuation member in the first direction and causes the second magnet to apply a second force on the second internal ferromagnetic actuation member in the first direction, wherein the first force and the second force are effective to linearly translate a valve stem, causing linear translation of a valve member into a first position; and
wherein linear translation of the external actuator in a second direction causes the first magnet to apply a third force on the first internal ferromagnetic actuation member in the second direction and causes the second magnet to apply a fourth force on the second internal ferromagnetic actuation member in the second direction, wherein the third force and the fourth force are effective to linearly translate the valve stem, causing linear translation of the valve member into a second position.

23. The method of claim 22, wherein a valve stem passes through an opening in the first internal ferromagnetic actuation member such that the linear translation of the external actuator in the first direction causes the first internal ferromagnetic actuation member to slide along the valve stem.

24. The method of claim 22, wherein:
the second internal ferromagnetic actuation member is rigidly coupled to the valve stem such that the linear translation of the external actuator in the second direction causes the second internal ferromagnetic actuation member to move along with the valve stem.

25. The method of claim 22, further comprising coupling the external actuator of the valve to a pneumatic valve actuator or hydraulic valve actuator.

26. A valve assembly, comprising:
a valve bonnet;
a valve stem disposed in the valve bonnet;
a valve member coupled to a distal end of the valve stem, the valve member movable between a first position in which the valve assembly is closed and a second position in which the valve assembly is open;
a first internal ferromagnetic actuation member encased in another material coupled to the valve stem;
a second internal ferromagnetic actuation member encased in another material coupled to the valve stem, wherein the first internal ferromagnetic actuation member and the second internal ferromagnetic actuation member are disposed in a spaced relationship along the valve stem; and
an external actuator slidably engaged to an exterior surface of the valve bonnet, the external actuator comprising:
a first magnet magnetically coupled to the first internal ferromagnetic actuation member through the valve bonnet; and
a second magnet magnetically coupled to the second internal ferromagnetic actuation member through the valve bonnet.

27. The valve assembly of claim 26, wherein the first internal ferromagnetic actuation member comprises an opening through which the valve stem is slidably engaged.

28. The valve assembly of claim 27, wherein:
the second internal ferromagnetic actuation member is rigidly coupled to the valve stem.

29. The valve assembly of claim 26, further comprising:
a spring disposed between the first internal ferromagnetic actuation member and the second internal ferromagnetic actuation member.
